(19) United States
(12) Patent Application Publication
(10) Pub. No.: US 2020/0226488 A1
(43) Pub. Date: Jul. 16, 2020

(54) Systems and methods for determining energy levels by automatically monitoring noise emitted by electrical devices

(71) Applicant: Stephen Wai Chiu Yu, Hong Kong (HK)

(72) Inventor: Stephen Wai Chiu Yu, Hong Kong (HK)

(21) Appl. No.: 16/246,507

(22) Filed: Jan. 13, 2019

(51) Int. Cl. G06N 20/00

(52) U.S. Cl. CPC G06N 20/00

(57) ABSTRACT

The present disclosure relates to systems and methods for interactive monitoring of energy by recording one or more bio-electronic logical signals and optionally sound signals. In one embodiment, simultaneous measurements are made to process signals with an energy detection algorithm, providing a display of energy data and using the data to interact with other software. In the embodiment, the energy data is transmitted to an internet server and shared by more than one person to form an energy network for social network.

### FIELD OF THE INVENTION

The presently disclosed technology generally relates to Systems and methods for determining energy levels by automatically monitoring noise emitted by electrical devices, and more specifically to monitoring energy by recording one or more bio-electronic logical signals and optionally sound signals.

### BACKGROUND OF THE DISCLOSED TECHNOLOGY

Energy levels energy levels are divided into two axes, namely: stimulation (e.g. composure-upbeat) and degree (positive energy and negative energy). From a technical point of view, these two axes can be referred to as low/high arousal (i.e. sadness and happiness) and low/high valence (i.e. pleasant and unpleasant). Thus such classified energy levels of a human being can be related to behavior and ultimately concerns habits in a social environment such as online social gaming or social media group can be broadly categorized into socially responsible habits, such as terror/madness/frustration (minus degree) and happiness/upbeat/delight (plus degree); or low stimulation states, such as demoralize/weak/lacking energy (minus degree) and loose/harmonious/ecstatic (plus degree). By monitoring the physiological attributes through biosignals obtained from the sensors, understanding of the mental states of a human being can understood and it can add a good element of entertainment in the gaming industry.

Basic algorithms exist for measuring certain attributes of physiological behavior. Skin conductance is a good example. It refers to a measure of the skin's ability to conduct electricity. An small electrical voltage is applied through a sensor, usually through a contact to a finger is made in order to establish an electric circuit where the client becomes a variable resistor. The realtime variation in conductance is emitted as wave signals, which is the inverse of the resistance, is calculated. Skin conductance represents changes in a nervous system. As the person becomes more or less excited, the skin's conductance increases or decreases proportionally. Mobile device, through a sensor located on either the side or the back of the mobile device, can be deployed the way that it is used in the current medical devices. The sensor, with built-in api provided by chip vendors, can be integrated into the casing of a mobile device or even a game remote controller.

Human energy levels have underlying bio-electronic logical correlates not only physical activity but also mental activity of the response system. A variety of bio-electronic logical signals have been used to detect energy levels. However, it is not easy to use bio-electronic logical data to monitor energy levels accurately because bio-electronic logical signals are susceptible to noises from many sources, particularly with moving persons, and the relationship between bio-electronic logical measures and plus or minus energy levels is not straightforward. A standard model separates energy levels into two axes: stimulation (e.g. composure-upbeat) and degree (minus-plus defined as nodes-edges). Thus energy levels is related to behavior and ultimately concerns habits in a social environment such as online social gaming or social media group can be broadly categorized into socially responsible habits, such as terror/madness/frustration (minus degree) and happiness/upbeat/delight (plus degree); or low stimulation states, such as demoralize/weak/lacking energy (minus degree) and loose/harmonious/ecstatic (plus degree).

The present invention is to include features to reduce belongings and improve the detection and monitoring of energy levels. In implementations of this invention, energy recognition algorithms, based on reports from several years of research and testing with military and clinical objects, derive energy stimulation and degree indices from bio-electronic logical signals. Energy-related data are calculated from bio-electronic logical signals and associated sound wave signals and communicated to and from a software application running on a server connected to the internet. In one implementation, energy data from multiple persons may be shared in an interactive network.

Previous systems to detect energy levels have typically been designed for laboratory use and are based on a fixed desktop computer. In contrast, our system is designed for personal use and can be based on a smart mobile device, thus enabling energy levels to be monitored in everyday surroundings. Moreover, the system is designed for multiple persons that can be connected in an interactive network whereby energy data can be collected and shared. The sharing of energy data, made possible by cellular communications, can be a way to enrich the experiences of persons interacting with a variety of social communities, media and, entertainment.

Multiple persons equipped with energy monitors can be connected directly, in peer-to-peer networks or via the internet, with shared energy data. Applications include multiplayer online-games, online social-media services, team sports, or other group activities. With many persons connected in a network, energy data can enhance social games, media, and communities. The energy data can be captured and analyzed for marketing purposes. Energy ratings can be collected via the internet for a variety of media, including written content, graphics, photographs, video and music. Energy levels can be linked to reactions which in turn linked to other sensory input such as taste and olfactory tests could also be obtained.

### SUMMARY OF THE INVENTION

The invention provide systems and methods for interactive monitoring of energy by recording one or more bio-electronic logical signals and optionally sound signals, in some cases using simultaneous measurements, and processing these signals with an energy detection algorithm, providing a display of energy data, and using the data to interact with games and other software. The energy data can be transmitted to an internet server and shared by more than one person to form an energy network for interactive games and social communities.

Bio-electronic sensors record bio-electronic logical signals that relate to changes in energy levels, such as body conductance, body temperature, respiration, heart rate, blood volume or pressure, and blood oxygen level. For a variety of these signals, either wet or dry electrodes can be utilized. Alternatively, a light source and light sensor can be utilized to record unusual heart pulse rating and blood pulse variation. The bio-electronic sensors can be deployed in a variety of forms, including a finger wearable, ring, hand wear, ear-bud, wrist-wearable, chest-wearable, or head-wearable. The sensors can be constructed into the outer case of a mobile game console or controller, a TV remote, a computer mouse, or other hand-held device; or into a case-cover that fits onto a hand-held device such as a mobile phone. In some cases, the bio-electronic sensors may be integrated into a secondary game controller that is in turn in information transmission with a standard game controller. For illustration, the bio-electronic sensors may be constructed into a game console, and the same is then plugged into a control. In some implementations, the bio-electronic sensors may be particularly useful in motion controllers such as remote controls for controlling consoles.

In some implementations of the invention, a plurality of bio-electronic sensors may simultaneously record bio-electronic logical signals, and the energy algorithm may receive these plurality of signals and employ the same in displaying energy data in responding to the energy data, such as for an energy network or for the control of interactive games. In such cases, a plurality of bio-electronic sensors may be employed to detect and employ energy signals in the game, or some bio-electronic sensors may be used for the motion signal analysis while others are used for other analysis, such as motion detection.

Bio-electronic logical signals are easily influenced by noise from a variety of sources, especially movements when moving. A variety of methods are used to improve the signal to noise ratio and remove unneeded belongings. Electrical bio-electronic sensors include electromagnetic shielding to reduce environmental noise, Since the contact between the bio-electronic sensor and underlying body could be undesirable through clothing or hair, the signals are connected to a very high-impedance input electronics. Capacitive-based bio-electronic sensors can be used in some applications. Another strategy is to use an array of bio-electronic sensors in the place of one, which allows for different contact points or those with the strongest signal source to be selected, and others used for belongings detection and active noise cancellation. A gyroscope can be attached to the bio-electronic sensor to aid monitoring and cancellation of movement of other belongings.

The signal is further processed to enhance signal processing and detecting and remove noise using algorithms based on signal separation methods and state of the art machine learning techniques. By way of showing, when detecting any unusual heart rate from a bio-electronic sensor designed for everyday use by consumers (in contrast to the medical sensors typically used in a clinical or research setting) the heart active system can be identified via a pattern recognition and a filter method with dynamic movement. Heart ticking thus detected are then put to a tracking algorithm based on probability, therefore increasing robustness to noise and signal sensitivity while maintaining responsiveness to rapidly changing heart activeness. Such signal processing may be particularly useful in cleaning data measured by such bio-electronic sensors, as person movement can be a significant source of signal-noise.

Monitoring energy level changes can enrich life-experiences for many people particularly in big cities where daily lives are busy with work. One application of this system is for entertainment, such as using energy data for interactive gaming, or interactive television and movies. Another application is for personal training, for illustration, learning to control energy level and maintain a healthy mental attitude for stress handling and management, yoga, meditation, sports performance management, nutrition, lifestyle or clinical studies and management. Others have used bio-electronic logical signals such as heart rate calculation and body conductance test for bio-electronic feedback trainers or to control games and other software. In implementing this invention the bio-electronic logical data are processed to obtain metrics for energy stimulation level and degree that provide the control signals for feedback and interactivity with the monitoring systems

### BRIEF DESCRIPTION OF THE DRAWINGS

FIG. 1 shows a system of monitoring energy data of a person in an online network activity, according to an embodiment of the present invention.

FIG. 2 illustrates a wearable device worn by a person.

FIG. 3 illustrates an energy monitoring device, according to embodiment of an invention.

### DETAILED DESCRIPTION OF EMBODIMENTS OF THE DISCLOSED TECHNOLOGY

References will now be made in detail to the present exemplary embodiments, examples of which are illustrated in the accompanying drawings. Certain examples are shown in the above-identified figures and described in detail below. In describing these examples, like or identical reference numbers are used to identify common or similar elements. The figures are not necessarily to scale and certain features and certain views of the figures may be shown exaggerated in scale or in schematic for clarity and/or conciseness.

Various terms are used for clarity herein. Definitions are given below. The term “object” as used herein indicates a human object. The term “person” is generally used to refer to the person of the device, which may be synonymous with the object. The term “information transmission” is used to mean any type of connection between components that allows information to be passed from one component to another. This term may be used in a similar fashion as “coupled”, “connected”, “information communication”, “data communication”, etc. The following are illustrations of information transmission schemes. As for wired techniques, a standard bus, serial or parallel cable may be used if the input/output ports are compatible and an optional adaptor may be employed if they are not. As for wireless techniques, radio frequency or microwaves, and optical techniques, including lasers or infrared (IR, and other such techniques may be used, A variety of methods and protocols may be employed for short-range, wireless communication including IEEE 802 family protocols, such as Bluetooth of 802.15, Wifi of 802.11, ZigBee of IEEE 802.15.4, Wireless USB and other personal area network methods, including those being developed. For wide-area wireless telecommunication, a variety of cellular, radio satellite, optical, or microwave methods may be employed, and a variety of protocols, including above noted IEEE 802 family protocols (e.g. 802.11, 802.16, or 802.20), Wi-Fi, Worldwide Interoperability for Microwave Access, ultra-wide band network, Voice-over-IP, Long-Term-Evolution used in 4G mobile communications standard, and other wide-area network or broadband transmission methods and communication standards being developed.

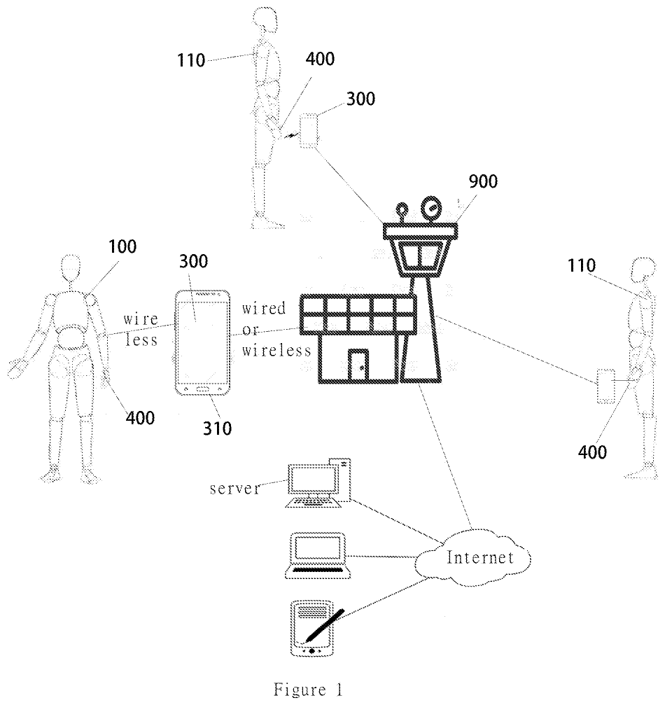

Various illustrations of the invention are now described in more detail. In FIG. 1, a system of the present invention is shown for monitoring energy data from one or more objects connected in a network via a communication tower 900. An object is in contact with one or more bio-electronic sensors to record bio-electronic logical signals. The object may be a local object 100 communicates with a remote object 110, In one example, both the local object 100 and the remote object 100 wear a wearable device 400. The wearable device 400 may include bio-electronic sensors, as shown on FIG. 1, and serve as an energy monitoring device. The wearable device may include a number of components including a signal processing unit 410, a gyroscope 420, and a wireless transmitter 430.

In another embodiment, an external device, including a cell phone, may include bio-electronic sensors and serve as energy monitoring device 300. The cell phone may, for example, include a controlled based sensor 330, a control unit 340, and a display 350. The bio-electronic sensors 320 can be deployed in a variety of forms, including a finger-wearable, gloves, e-rings, glove-wearing, ear wearing, wrist-wearable, hand-wearable, chest-wearable or head-wearable. Other varieties of bio-electronic sensors can also be deployed. In one embodiment, a bio-electronic sensor is included in

The bio-electronic logical signals are transmitted to an energy-level monitor device 300 by a wired or short-range wireless connection. As described above, energy level monitoring device further processes the bio-electronic logical signals and an algorithm derives energy data from the signals, such as stimulation and degree indices. Screen displays energy data to object.

An energy level monitoring device is connected to a telecommunication network via a wide area, wired or wireless connection. The telecommunication network is connected to a server that is part of the internet infrastructure. Energy level monitoring device optionally transmits the energy data to a website associated with an application program running on computer readable media in server, which receives, processes and responds to the data. The computer readable media in server and elsewhere may be in non-transitory form. A response can be transmitted back to energy level monitoring device. The server may also transmit energy data via connection to be displayed to other remote objects. The remote objects are equipped with an energy level monitoring device and bio-electronic sensors and may similarly transmit their energy data to an internet server. The server application program stores the energy data and interacts with the persons, including sharing energy data among the network of persons as required for activities such as games and enriching social networks.

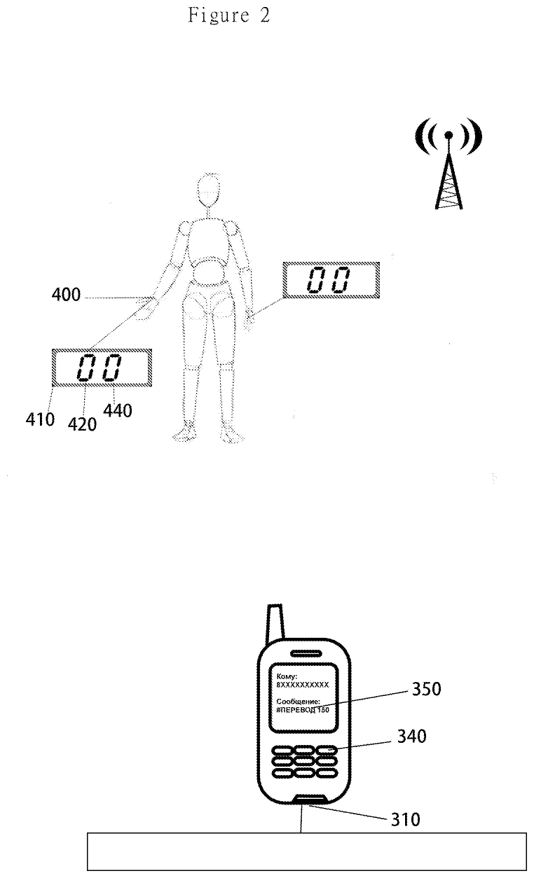

In FIG. 2, an illustration of energy level monitoring device is shown based on a web-enabled, mobile phone. One or more bio-electronic sensors measure bio-electronic logical signals from an object. A number of types of bio-electronic sensors may be employed that measure signals related to changes in energy levels, such as body conductance, body temperature, heart rate, blood volume and blood oxygen levels. For a variety of these signals, either wet or dry electrodes, or alternatively, optical sensors can be employed. A number of wearable and planting sensors may also be employed. The bio-electronic sensors are incorporated in a finger wearable, glove, ear clip (e.g. attached to a cell phone, wrist-wearable, chest-band, head-wearable, or adhesive clothing material as a means of attaching the bio-electronic sensors to the object. The signals are amplified and processed to reduce belongings in a signal processing unit. A gyro or accelerometer related-device optionally may be included to aid monitoring and cancellation of movement belongings. A short-range wireless is employed to transmit the signals via connection such as Bluetooth to a web-enabled, mobile phone. An optional adapting device connected to the generic input/output port or docking-connector of the mobile phone may be employed to receive the signals. Alternatively, signal processing unit can connect by means of a direct or wired connection to the mobile phone. An application program is downloaded from an Internet server to a digital chip in the mobile phone. The application program receives and processes the bio-electronic logical signals and includes an algorithm to derive energy data. The program includes a person interface to display the energy data on screen, and for the object to manually enter information by means of a keyboard, buttons or touch screen. As illustrated in FIG. 1, the mobile phone optionally transmits the energy data via antenna to the internet server, and may receive energy data of other persons.

It will be clear to one of ordinary skill in the art given this teaching that mobile phone may be replaced with other types of wireless devices such as a desktop computer, laptop computer, entertainment console, television smart device, smart watch, computer mouse, or other hand-held device, such as proprietary hardware, provided that such devices have equivalent functionality. The advantage of a web-enabled wireless phone (in contrast to a personal computer or video game console) is that it enables a person's energy level to be monitored and shared with others when the person is fully mobile in a wide-area environment, such as walking around a store. However, the limited amount of memory, processing capability, and display size available on a mobile phone in comparison to a computer constrains the functionality of the software running on the phone. Application program is thus designed to suit the functional constraints of mobile phone. In the case of an energy network that might encompass a large number of persons, it is important that the internet infrastructure is employed for significant application processing and storage of energy data so that less memory and processing capabilities become necessary on the mobile phone, thus freeing memory and processing for receiving bio-electronic logical signals and calculating the related energy data.

Web-enabled mobile phones have brought increased functionality for sending and receiving data from the internet. A web-enabled or smart phone is distinguished from conventional cellular phones by features such as a web browser to access and display information from internet web sites. In addition, modern, web-enabled mobile phones run complete operating system software that provides a platform for, mobile application programs or apps. Third party applications, such as described here, can be downloaded immediately to the phone from a digital distribution system website over a wireless network without using a PC to load the program. With increased functionality, the smart phone operating systems can run and multi-task applications that are native to the underlying hardware, such as receiving data from an input port and from the internet, at the same time as running other applications using the data. Similarly, a web-enabled tablet has the advantage of enhanced mobility, by reason of compactness, in contrast to a conventional desktop or even laptop computer; and it has the advantages of an operating system that can run a web browser, download apps from a web site, and multitask application programs, e.g. simultaneously receiving data and running a program to access an online social network, in contrast to a conventional personal digital assistant.

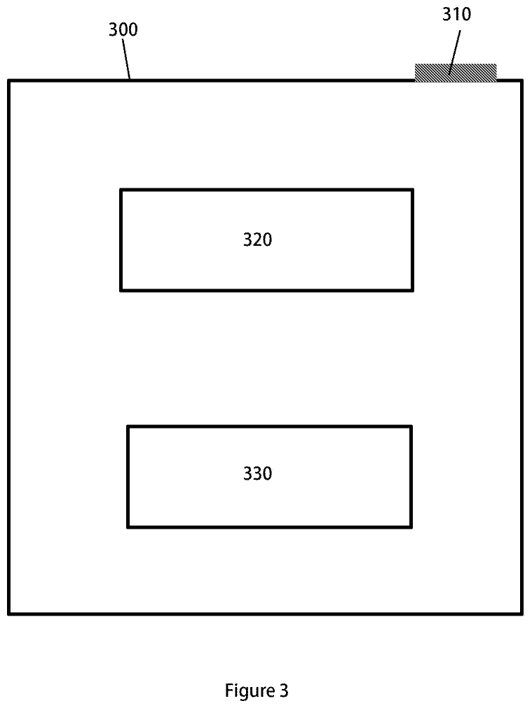

In FIG. 3, an illustration of energy level monitoring device is shown based on a web-enabled, mobile phone with bio-electronic sensors integrated into the casing of the phone. The phone incorporates one or more bio-electronic sensors to measure bio-electronic logical parameters that relate to changes in energy levels, such as body conductance, body temperature, heart rate, blood volume pulse, blood oxygenation, and electrocardiogram. For a variety of these signals, either wet or dry electrodes, or optical sensors, are utilized. The bio-electronic sensors may be located in a depression to facilitate finger contact. Alternatively, there may be an array of bio-electronic sensors, conductive strip, optical fibers, or other means to enable an object's fingers to be in different positions but still connect to the bio-electronic sensors, and which allows those bio-electronic sensors with the strongest signal source to be selected and others used for belongings detection or noise cancellation. A pressure or touch-sensitive sensor in connection to the bio-electronic sensors measures finger contact to assist in the detection of belongings. The bio-electronic sensors are connected to a signal processing unit which amplifies and processes the bio-electronic logical signals to remove belongings using techniques described above. An accelerometer may be included to aid monitoring and cancellation of movement belongings.

An application program is downloaded to mobile phone to derive and display energy data on screen as previously described. The energy-deriving algorithms may be implemented in firmware in the mobile phone, in which case the application program receives and displays the energy data. The energy data may be integrated with other features of the application, such as a game or personal training program. The energy data optionally may be transmitted to an internet server, and the energy data of other persons displayed as in the first illustration. It will be clear to one of ordinary skill in the art given this teaching that bio-electronic sensors may similarly be integrated into other types of handheld devices in place of mobile phone, such as a desktop computer, laptop computer, entertainment console, television smart device, smart watch, computer mouse, or arm band, provided that such devices have equivalent functionality. In some cases, the bio-electronic sensors may be integrated into a game controller, that is in turn in information transmission with a standard game controller or console, which runs an application program to receive and display the energy data. As in the case with an application on the mobile phone, the standard game controller or console may download energy monitoring and energy community applications from the internet, as well as display applications for such data.

An illustration of energy level monitoring device is shown in which the bio-electronic sensors are incorporated in a cover that is designed to slip over or snap on a mobile phone. The cover is equipped with similar bio-electronic sensors, or a variety of bio-electronic sensors, finger-wearable, and contact-sensors, as described in the previous illustration. The bio-electronic sensors are connected to Signal Processing Unit which amplifies and processes the bio-electronic logical signals to remove belongings as described above. The signals are linked by means of cable to connector that plugs into the generic input and output port of the mobile phone. Signal Processing Unit and connector may be combined in one unit. Alternatively, Signal Processing Unit may connect with mobile phone by means of a short-range wireless transmitter such as Bluetooth. An application program running on the mobile phone derives energy data. Alternatively, the energy-deriving algorithms may be implemented in firmware in Signal Processing Unit or connector. The energy data can be displayed, transmitted to the Internet, stored on a server, and shared with other persons, as described in the previous illustrations, Instead of mobile phone, a cover can be designed for other types of handheld devices, such as a tablet, game controller, TV remote controller, motion detector, or computer mouse. On some devices, the cover may be in the form of a wearable that fits part of the device like on the handles of a game console or is in the form of a tablet attached by means of adhesive-material contact.

An energy monitoring network is further illustrated. A person starts an application program (which in some implementations may constitute a very thin client, while in others may be very substantial) in an energy level monitoring device, the application program having been previously loaded into the energy level monitoring device. A bio-electronic sensor measures a bio-electronic logical signal. The bio-electronic sensor sends the signal to a Signal Processing Unit which amplifies the signal and reduces belongings and noise in the signal. The Signal Processing Unit transmits the processed signal via a wired or wireless connection to the energy level monitoring device. The energy level monitoring device further processes the signal and calculates a variety of energy related data, such as energy stimulation and degree measures. The energy level monitoring device displays the energy data to the person and transmits the energy data to an internet server via a telecommunications network. An application program resident on the internet server processes the energy data and sends a response to the person. It should be noted that the application program may reside on one or more servers or cloud-based infrastructure connected to the internet and the term “response” here is used generally. The internet server then transmits the energy data to one or more remote persons equipped with an energy level monitoring device where the energy data is displayed. The remote person's energy level monitoring device similarly calculates their energy data from bio-electronic logical signals and transmits it to an internet server to be shared with other persons. The group-sharing may be accomplished in a number of ways, and for a number of purposes. In some cases, aggregate data may be combined and analyzed statistically according to the requirements of the person. In other cases, individual energy data may be employed to notify another person or a group of persons of an individual or object person's energy state. In still other cases, individual energy data may be employed to control an avatar in or other aspects of a multiplayer game. In general, a signal corresponding to energy-based data may be employed as the basis for calculation, where the calculation is in a videogame, social community, control system, or a similar system.

Any of the operations described that form part of the presently disclosed embodiments may be useful machine operations. Various embodiments also relate to a device or an apparatus for performing these operations. The apparatus can be specially constructed for the required purpose, or the apparatus can be a general-purpose computer selectively activated or configured by a computer program stored in the computer. In particular, various general-purpose machines employing one or more processors coupled to one or more computer readable medium, described below, can be used with computer programs written in accordance with the teachings herein, or it may be more convenient to construct a more specialized apparatus to perform the required operations.

The procedures, processes, and/or modules described herein may be implemented in hardware, software, embodied as a computer-readable medium having program instructions, firmware, or a combination thereof. For example, the functions described herein may be performed by a processor executing program instructions out of a memory or other storage device.

The foregoing description has been directed to particular embodiments. However, other variations and modifications may be made to the described embodiments, with the attainment of some or all of their advantages. It will be further appreciated by those of ordinary skill in the art that modifications to the above-described systems and methods may be made without departing from the concepts disclosed herein. Accordingly, the invention should not be viewed as limited by the disclosed embodiments. Furthermore, various features of the described embodiments may be used without the corresponding use of other features. Thus, this description should be read as merely illustrative of various principles, and not in limitation of the invention.

What is claimed:

1. A method for monitoring energy data of a person in an online network activity using a mobile phone comprising, by one or more computing devices:
accessing energy associated with a first set of behaviors through a bio-electronic sensor and sound sensor, each behavior being associated with one or more socially responsible habits;
generating a second set of behaviors from the first set of behaviors by applying a first filtering criteria to the first set of behaviors;
scoring each behavior in the second set of behaviors based on the socially responsible habits associated with each behavior;
generating a training set of behaviors from the second set of behaviors by selecting each behavior from the second set of behaviors having a score greater than a first threshold score, each behavior in the training set being associated with a first positive signal; and
determining an behavior-counseling algorithm for the first positive signal, the behavior-counseling algorithm being determined through an iterative training process performed one or more times, each iteration of the iterative training process comprising:
training an initial behavior-counseling algorithm based on the socially responsible habits associated with the behaviors in the training set of behaviors;
accessing a third set of behaviors associated with the circle of behavior;
benchmarking, using the initial behavior-counseling algorithm, each behavior in the third set of behaviors based on an analysis of the socially responsible habits associated with each behavior, one or more of the behaviors in the third set of behaviors being benchmarked with the first positive signal;
training a revised behavior-counseling algorithm based on the socially responsible habits associated with the behaviors in the third set of behaviors having the first positive signal;
accessing a fourth set of behaviors associated with the circle of behavior, the fourth set of behaviors being generated by applying a second filtering criteria to a fifth set of behaviors associated with the circle of behavior;
benchmarking, using the revised behavior-counseling algorithm, each behavior in the fourth set of behaviors based on an analysis of the socially responsible habits associated with each behavior, one or more behaviors in the fourth set of behaviors being benchmarked with the first positive signal; and
generating a sixth set of behaviors from the fourth set of behaviors by selecting each behavior from the fourth set of behaviors having a score greater than a second threshold score, each behavior in the sixth set of behaviors being associated with the first positive signal, wherein the sixth set of behaviors is to be used as the training set in a next iteration of the iterative training process.

2. The method of claim 1, further comprising:
accessing a circle of behavior comprising a plurality of nodes and a plurality of edges connecting the nodes, each node corresponding to an behavior associated with the circle of behavior.

3. The method of claim 1, wherein scoring each behavior in the second set of behaviors comprises:
determining, for each behavior in the second set of behaviors, a score for each socially responsible habit associated with the behavior; and
combining, for each behavior in the second set of behaviors, the scores for the socially responsible habits to produce an behavior score.

4. The method of claim 1, wherein the first threshold score is greater than 90% of the scores of the behaviors in the second set of behaviors.

5. The method of claim 1, wherein benchmarking each behavior in the third set of behaviors comprises comparing the socially responsible habits associated with an behavior in the third set to features associated with the initial behavior-counseling algorithm to determine whether the behavior is benchmarked with the first positive signal.

6. The method of claim 1, wherein benchmarking each behavior in the fourth set of behaviors comprises comparing the socially responsible habits associated with an behavior in the fourth set to features associated with the revised behavior-counseling algorithm to determine whether the behavior is benchmarked with the first positive signal.

7. The method of claim 1, wherein training the initial behavior-counseling algorithm is further based on the revised behavior-counseling algorithm trained in a prior iteration of the iterative training process.

8. The method of claim 1, wherein training through the bio-electronic sensor includes a finger wearable, ring, hand wear, ear-bud, wrist-wearable, chest-wearable, or head-wearable.

9. The method of claim 1, wherein accessing the energy associated with the first, second, and third set of behaviors is done through the bio-electronic sensor and the sound sensor to better assess the energy situation of the person when conducting social gaming multimedia devices.
